(19) United States
(12) Patent Application Publication
(10) Pub. No.: US 2023/0019324 A1
(43) Pub. Date: Jan. 19, 2023

(54) SADDLEBAG BIRD FEEDER

(71) Applicant: Harvey Reese, Philadelphia, PA (US)

(72) Inventor: Harvey Reese, Philadelphia, PA (US)

(21) Appl. No.: 17/377,542

(22) Filed: Jul. 16, 2021

(51) Int. Cl. A01K 39/014; E06B 7/28; F21S 9/03; F21V 23/04; F21V 21/08

(52) U.S. Cl. CPC A01K 39/014; E06B 7/28; F21S 9/03; F21V 23/04; F21V 21/08

(57) ABSTRACT

A saddlebag bird feeder is for mounting across a window sill of a window, and has a ballast bag, and a flexible strap having a first end, a middle portion, and a second end. The first end of the flexible strap being connected to the ballast bag. A window sill abutment member is connected to the second end of the ballast bag. There is a frame portion connected to the window sill abutment member, and a tray is included which is removably received in the frame portion, the frame being adapted to support the tray outside the window; and the tray being adapted to hold bird seed for feeding birds.

### CROSS REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The present invention relates to bird feeders, and more specifically relates to bird feeders that are mounted on the outside of windows of houses.

### BACKGROUND OF THE INVENTION

It is a problem in the art to provide bird feeders, and many examples are known. For example, there are window bird feeders that attach to a window with suction cups. This is fine for first floor applications because the user can step outside to attach the bird feeder and step outside from time to time to replenish the bird feed. However, this doesn't work for upper floors or apartment dwellers, since they cannot simply walk outside to attached the birdfeeder or replenish the bird feed.

### SUMMARY OF THE INVENTION

From the foregoing, it is seen that it is a problem in the art to provide a device meeting the above requirements. According to the present invention, a device is provided which meets the aforementioned requirements and needs in the prior art.

The device of the present invention is a Saddlebag Bird Feeder, which in a preferred embodiment has a vinyl strap with a bird feeder at one end and a water-filled ballast bag at the other. All that's required of the user is to fill the ballast bag, open the window and drape the feeder outside. The bird feeder can be retrieved by pulling in the bird feeder using the strap, and the bird feed can thereby easily be replenished.

The saddlebag bird feeder is for mounting across a window sill of a window, the window sill having an outermost extent, the saddlebag bird feeder comprising:

a ballast bag;

a flexible strap having a first end, a middle portion, and a second end; said first end of said flexible strap being connected to said ballast bag;

a window sill abutment member connected to said second end of said ballast bag;

a frame portion connected to said window sill abutment member; and

a tray which is removably received in said frame portion, said frame being adapted to support said tray outside the window; and said tray being adapted to hold bird seed for feeding birds;

whereby said ballast bag is disposed inside the window, with said strap extending across the window sill, and said window sill abutment member abutting the outermost extent of the window sill, such that said ballast bag pulls said strap to urge said window sill abutment member into abutment with the outermost extent of said window sill such that said window sill abutment member is held in place against the window sill so that said tray is supported.

The invention further being directed to a decorative light assembly for mounting across a window sill of a window, the window sill having an outermost extent, comprising:

a ballast bag;

a flexible strap having a first end, a middle portion, and a second end; said first end of said flexible strap being connected to said ballast bag;

a window sill abutment member connected to said second end of said ballast bag;

a frame portion connected to said window sill abutment member;

a plurality of decorative lights supported by said frame;

a power source connected to said decorative lights;

a solar power array supported by said frame portion;

said power source including a battery, said power source being connected to said solar power array to store power.

Other objects and advantages of the present invention will be more readily apparent from the following detailed description when read in conjunction with the accompanying drawings.

### BRIEF DESCRIPTION OF THE DRAWINGS

FIG. 1 is a perspective view of a portion of a saddlebag window bird feeder according to the present invention.

FIG. 2 is a perspective view of one end of the saddlebag window bird feeder of FIG. 1 which is mounted on a window sill, with a tray added for holding bird feed.

FIG. 3 is a perspective view of a portion of the saddlebag window bird feeder of FIG. 1 that is disposed inside the window.

FIG. 4 is a perspective view of an alternative embodiment of the invention, in which a portion of the saddlebag window bird feeder of FIG. 1 that is outside the window has a solar panel that provides power to holiday decorative lights.

FIG. 5 is a schematic side view of an embodiment of a connector for connecting a strap portion to a wire frame portion, wherein the wire frame portion forms a holder for a tray that holds bird feed.

FIG. 6 is a schematic diagram showing the elements of the embodiment of FIG. 4, including the solar panels, a battery, an ON/OFF switch, and the decorative lights.

FIG. 7 is a view of a wire frame portion, which forms an alternative embodiment of the tray holder section.

FIG. 8 is another embodiment of the saddlebag bird feeder 100, having a rectangular tray and a rectangular frame support.

FIG. 9 is a perspective view of the embodiment of FIG. 8 mounted outside the window on a window ledge, having the rectangular box.

FIG. 10 is an embodiment of the rectangular frame of FIG. 8, showing an upper frame portion having bars forming an opening to receive a rectangular bird feeder, and having bars forming a support frame portion, to support the weight of the bird feeder.

FIG. 11 is a schematic side view showing the portion of the saddlebag bird feeder 100 that is disposed outside of the window.

FIG. 12 is a schematic top view of a window sill abutment portion and the wire frame portion of FIG. 11.

FIG. 13 is a perspective view showing a further embodiment of a bird feeder support structure in phantom outline, showing a flat extension member with struts connected to the lower portion of the window sill abutment member.

FIG. 14 shows a perspective view of the further embodiment of FIG. 14, showing the flat extension member in solid outline.

FIG. 15 is a schematic side view of the embodiment of FIGS. 13 and 14.

### DETAILED DESCRIPTION OF THE INVENTION

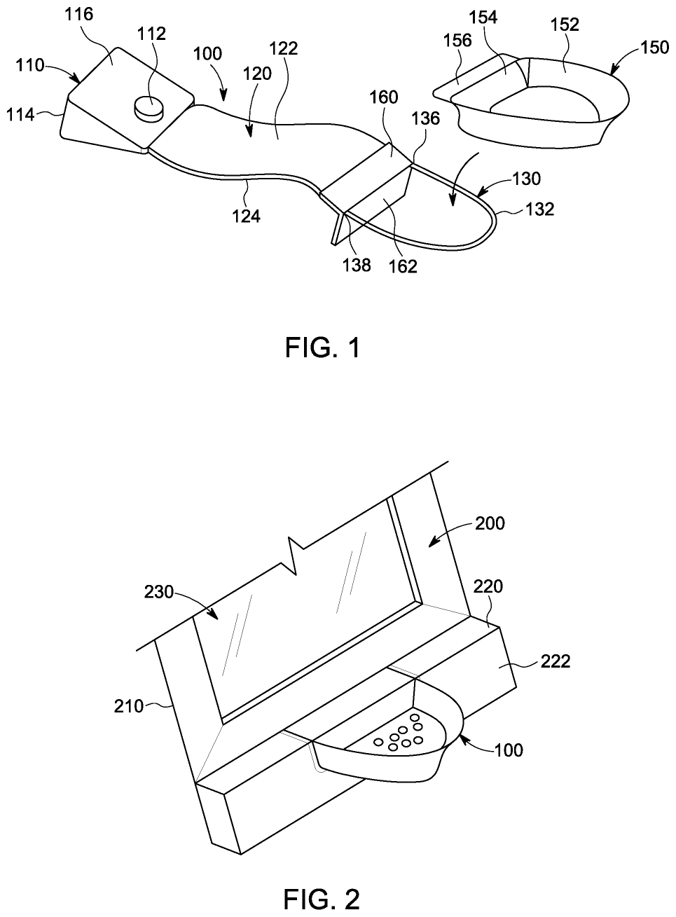

FIG. 1 is a perspective view of a saddlebag window bird feeder 100 according to the present invention. The saddlebag bird feeder 100 as shown in FIG. 1 has a vinyl strap 120 with a bird feeder 150 on a bird feeder support member 130 at one end, and a user-fillable ballast bag 110 at the other end. The user will be inside a room having a window, the window having a window sill where the saddlebag bird feeder 100 is intended to be mounted. All that's required of the user is to fill the ballast bag 110 with ballast material, open the window where the saddlebag bird feeder 100 is to be placed, and then drape the saddlebag bird feeder 100 outside. The saddlebag bird feeder 100 can be retrieved by the user by pulling in the saddlebag bird feeder 100 using the strap 120, and the saddlebag bird feeder 100 can thereby easily be replenished with birdseed.

The above-mentioned ballast material for use in the user-fillable ballast bag 110 preferably includes any of the following ballast materials: water, sand, gravel, marbles, etc. The amount of ballast can be selected by the user to partially or completely fill the ballast bag 110, and an amount should be added sufficient to keep the bird feeder 100 in place.

It will be understood that the strap 120 can be of material other than vinyl, and the material is preferably any flexible material that does not deteriorate over time when exposed to the outdoor elements. This includes other types of plastic materials known to any one having skill in plastic technologies, as well as treated woven or unwoven materials that can withstand being exposed to the outdoor elements. While a continuous strap 120 is shown, the strap can instead be composed of a number of smaller elements linked together similar to treads on a tank; and in this case the elements can be of any material including metal, plastic, woven, or non-woven, that can withstand being exposed to the outdoor elements.

While the ballast bag 110 is described as being filled with water, it can be filled with other ballast material such as sand, pebbles, marbles, and/or any other fill material that can serve as ballast. The ballast bag 110 is preferably composed of any material used for bags, and is any waterproof material which can be used to contain water.

As shown in FIG. 1, the ballast bag 110 has a spout cover 112 which covers a spout or opening in the ballast bag 110 (the spout not being separately shown). The spout is preferably like that of a canteen spout, on canteens used by outdoorsmen; and other spouts can be used such as a valve-type closure operated by turning, or a plug type wherein a simple rubber plug is inserted into the spout opening in the bag 110.

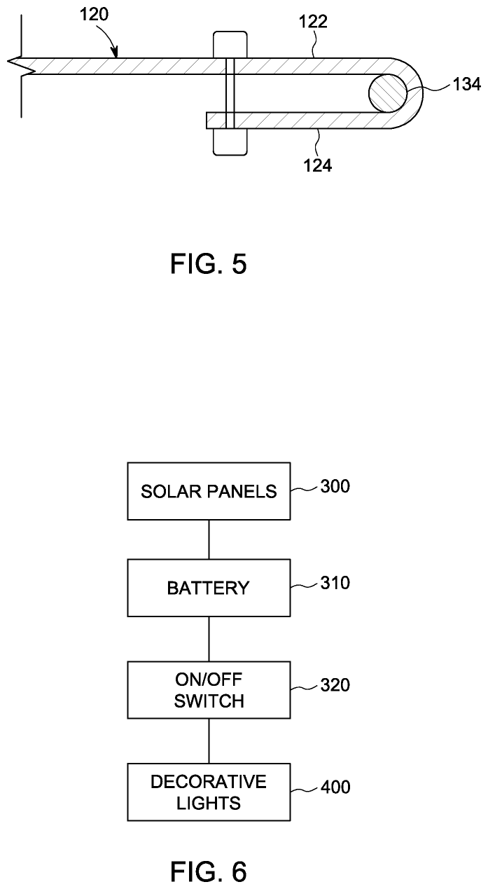

The ballast bag has a front surface 116 which is identical to a rear surface (not shown), and a perimeter surface 114 which connects the front and rear surfaces thereby forming a saddlebag-like pouch or container. The saddlebag 110 is connected at its apex to the strap 120. The connection of the saddlebag 110 to the strap 120 can be by any connecting means, such as a pin (similar to that shown in FIG. 5), by sewing or stitching, by welding including ultrasonic welding used to secure two pieces of plastic together, chain links, and any other connecting means known to anyone skilled in the manufacturing arts.

The strap 120 has an upper surface 122 and a lower surface 124, and is connected at a first end to the ballast bag 110 and is connected at a second end to the window sill abutment member 160. The window sill abutment member 160 in this embodiment is a member shaped at a ninety degree angle such that there is a top horizontal surface portion from which a lower vertical portion 162 extends downwardly. The lower vertical portion 162 is adapted to abut against an outer portion of the windowsill so that the weight of the ballast bag 110 does not pull the strap 120 back into the interior of the house through the open window. The top horizontal portion of the window sill abutment member 160 is adapted to overlie and rest upon the windowsill. A frame portion 130 is connected to the lower vertical portion at a first end 136 and at a second end 138, wherein the lower vertical portion provides a cantilever support so that the frame portion 130 can receive a bird feed tray 150. The connection of the wire frame portion 130 to the portion 162 can be any secure connection such as use of bolts, a threaded connection, and by passing the frame portion through the portion 162 and bending it so that it is stably connected; all connecting means are contemplated which would be known to anyone skilled in the construction and carpentry arts.

The bird feed tray 150 has an upstanding sidewall 152 and a base (unnumbered in FIG. 1), a back wall 154, and a lip portion 156. The sidewall 152 flares outwardly so that the base can fit into the frame portion 130 until the sidewall 152 contacts the frame portion 130 to thereby support the tray 150. The lip portion 156 also rests on the frame portion 130 to further support the tray 150, as well as to facilitate handling of the tray 150 when handling it.

FIG. 2 is a perspective view of one end of the saddlebag window bird feeder 100 of FIG. 1 which is mounted on a window sill, wherein the window sill has an upper portion 220 and a lower vertical portion 222. This view shows the tray 150 in place; the bird feed is schematically depicted by small circular elements (unnumbered) in FIG. 2. Thus, the tray 150 is added for holding the bird feed. A window frame 200 is shown having a window 230. In use, the window 230 is raised by the user, then the strap portion 120 and the window sill abutment member 160 of the saddlebag bird feeder 100 are extended through the open window 200, and the portion 162 of the window sill abutment member 160 is placed so that it engages the portion 222 of the window sill.

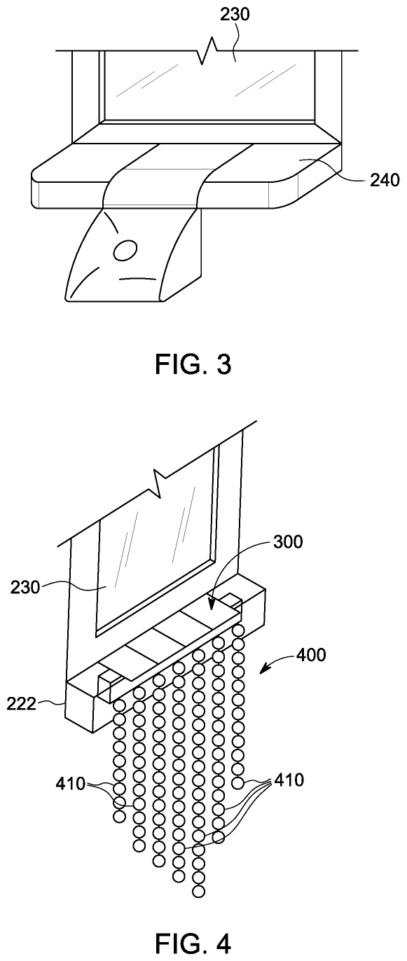

FIG. 3 is a perspective view of a portion of the saddlebag window bird feeder 100 of FIG. 1 that is disposed inside the window 230. Here, the window is show having an interior window sill portion 240 upon which the strap 120 rests (the strap 120 and ballast bag 110 not being numbered in FIG. 3 for the sake of clarity).

FIG. 4 is a perspective view of an alternative embodiment of the invention, in which a portion of the saddlebag bird feeder of FIG. 1 that is outside the window has a solar panel 300 and decorative lights 400 having a plurality of strings of lights 410, schematically shown. The solar panel 300 provides power to the decorative lights 400. As shown schematically in FIG. 4, the solar panels 300 rest upon a wire frame (unnumbered in FIG. 4), wherein the other parts are the same as in FIGS. 1-3 except that the frame 130 and tray 150 are replaced by the solar panel 300 and the holiday lights 400 supported on the wire frame (unnumbered) which is attached to the strap 120.

FIG. 5 is a schematic side view of an embodiment of one type of possible connector for connecting the strap portion 120 to a wire frame portion 134, wherein the wire frame portion 134 forms part of the frame portion 130. This type of possible connector, using a pin 134, allows the strap 120 to be wound around the pin 134 once and secured by a bolt member (unnumbered) onto itself. As discussed above, other connecting means are possible and all such variations which would be known to any one having skill in the manufacturing arts are contemplated as being encompassed by the present invention.

FIG. 6 is a schematic diagram showing a schematic of elements used in FIG. 4, including the solar panels 300 (discussed above with regard to FIG. 4), a battery 310, an ON/OFF switch 320, and the decorative lights 400. By this diagram, it is shown that the solar panels 300 provide power to the battery 310, which in turn provide power to the decorative lights 400, and this power can be controlled by the ON/OFF switch 320.

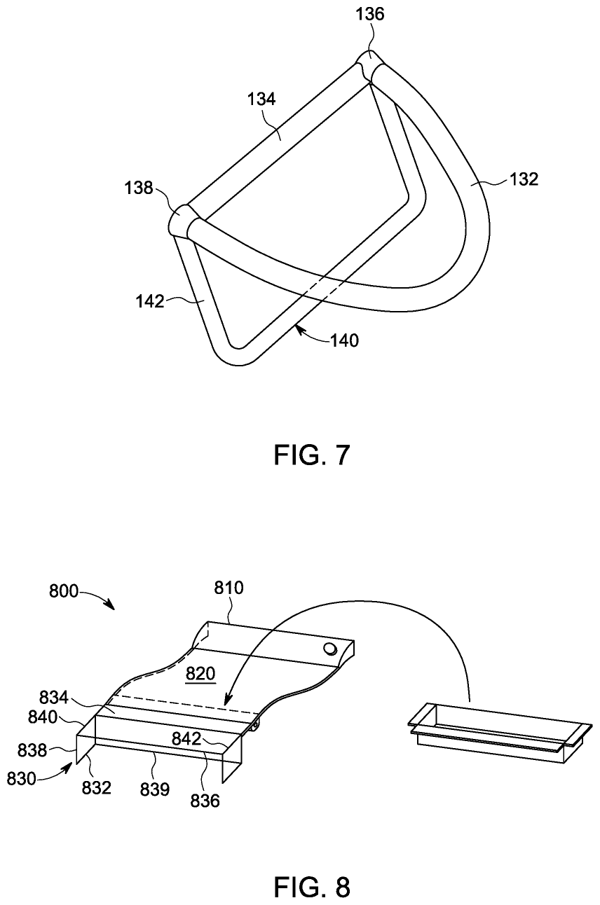

FIG. 7 is a view of a wire frame portion 140, which forms an alternative embodiment of the tray holder section. Here, the frame portion 140 having a U-shaped portion 142, replaces the lower (solid) portion 162 of FIG. 1. In this embodiment, the U-shaped portion 142 abuts against the window sill, holding the device in place against the weight of the ballast bag 110. Here, the wire frame portion 140 includes a bar 134, and connecting points 136 and 138 where the portion 132 meets the bar 134. This wire frame portion can be made of metal such as cast iron, or any other metal which can be formed and can support the device in place against the weight of the ballast bag. In FIG. 7, the angle between a plane containing the portion 132 and the plane containing the portion 142 is preferably ninety degrees, though other angles are possible and such deviations from this preferred ninety degree angle are also encompassed by the present invention.

FIG. 8 is another embodiment of the saddlebag bird feeder 100, having a rectangular tray (unnumbered in FIG. 8) and a rectangular frame support 830. Here, a strap portion 820 is shown and a ballast bag 810 is shown, corresponding to the like elements of FIG. 1 discussed above. The support 830 has a horizontal portion 834 for resting upon a window sill, and wire frame elements 840, 836, and 842 forming a receptacle for the rectangular tray. The other wire frame elements 838, 839, and 832 are for support of the weight of the rectangular tray. Other shapes of tray are also contemplated as being within the scope of the present invention.

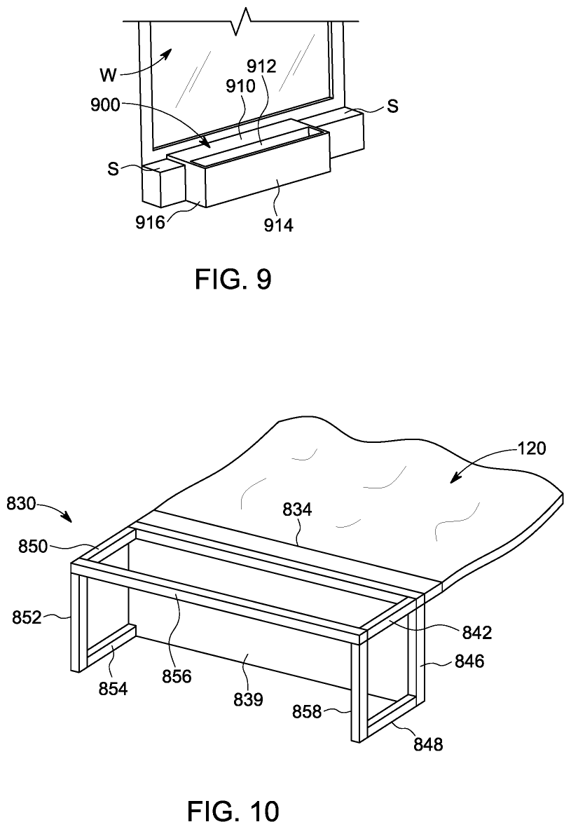

FIG. 9 is a perspective view of the embodiment of FIG. 8 mounted outside the window on a window ledge, having a rectangular box 900. Here, the box has a front 914, a side 916, and a horizontal portion 910 for engaging the window sill to support the rectangular box 900. In the view, there is a window W and a window sill S. A bird feed tray 912 is shown disposed in the box 900.

FIG. 10 is an embodiment of the rectangular frame of FIG. 8, showing an upper frame portion 830 having prismatic bars 842, 850, and 856 forming an opening to receive a rectangular bird feeder (not shown in this view), and having bars 852, 854, 846, 848, and 858 forming a support frame portion, to support the weight of the bird feeder tray (not shown). Here, the abutment portion 160 is formed by a horizontal portion 834 and a vertical portion 839.

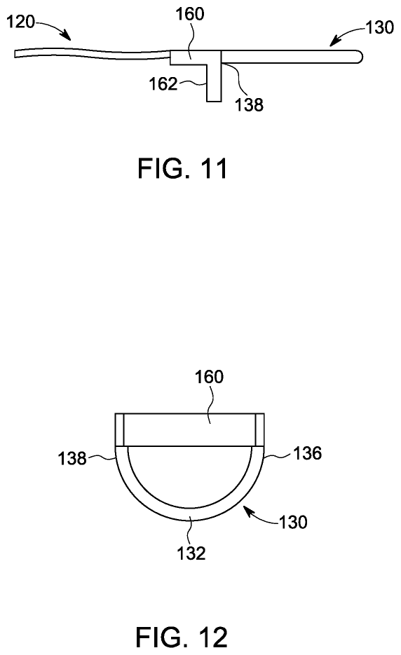

FIG. 11 is a schematic side view showing the portion of the saddlebag bird feeder 100 that is disposed outside of the window, in the embodiment of FIG. 1. The elements include the strap portion 120, the wire frame 130, and the horizontal portion 160 as well as the downward vertical portion 162. The connection point 138 of FIG. 1 is also shown.

FIG. 12 is a schematic top view of a window sill abutment portion and the wire frame portion of FIG. 11. The like numerals have the same like meaning.

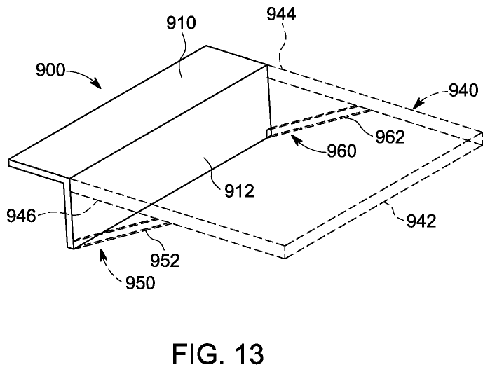

FIG. 13 is a perspective view showing a further embodiment of a bird feeder support structure in phantom outline, showing a flat extension member 940 with struts 952 and 962 connected to a lower portion 912 of a window sill abutment member 900. The member 900 also has a horizontal portion 910. The member 940 has a front end 942, a right side 944, and a left side 946. Here, the left side support is generally designated 950 and the right side support is generally designated 960.

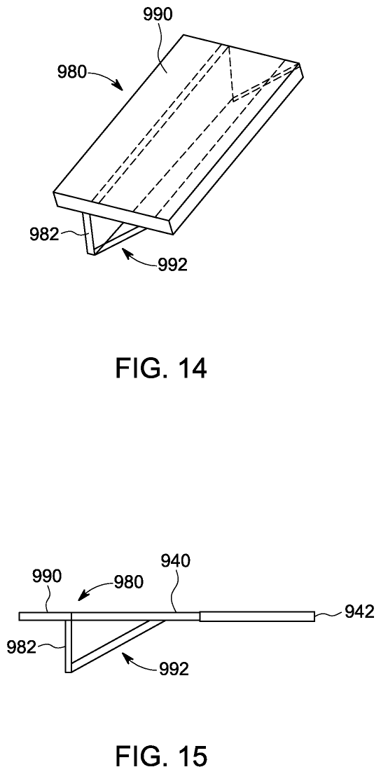

FIG. 14 shows a perspective view of a further embodiment similar to that of FIG. 14, showing an abutment member 900 having an upper horizontal portion 990 and a lower vertical portion 982, with a flat beam-like member 992 providing support for the portion 990. This view is not to the same scale as FIG. 13, but is intended to show its construction.

FIG. 15 is a schematic side view of the embodiment of FIG. 13 and FIG. 14. with the same elements having like numerals, and wherein an intermediate portion 940 is shown, and showing the end portion 942.

The invention being thus described, it will be evident that the same may be varied in many ways by any one having skill in the applicable arts. Such variations are not to be regarded as a departure from the spirit and scope of the invention and all such modifications are intended to be included within the scope of the claims.

1. A saddlebag bird feeder for mounting across a window sill of a window, the window sill having an outermost extent, comprising:
a ballast bag;
a flexible strap having a first end, a middle portion, and a second end; said first end of said flexible strap being connected to said ballast bag;
a window sill abutment member connected to said second end of said ballast bag;
a frame portion connected to said window sill abutment member; and
a tray which is removably received in said frame portion, said frame being adapted to support said tray outside the window; and said tray being adapted to hold bird seed for feeding birds;
whereby said ballast bag is disposed inside the window, with said strap extending across the window sill, and said window sill abutment member abutting the outermost extent of the window sill, such that said ballast bag pulls said strap to urge said window sill abutment member into abutment with the outermost extent of said window sill such that said window sill abutment member is held in place against the window sill so that said tray is supported.

2. The saddlebag bird feeder of claim 1, wherein said window sill abutment member has an L-shaped body having a first portion attached to said strap and a second portion adapted to engage the outermost extend of the window sill.

3. The saddlebag bird feeder of claim 1, wherein said frame portion is composed of metal and has an arcuate shape.

4. The saddlebag bird feeder of claim 1, wherein said tray has an outer lip portion adapted to rest upon said frame portion, and wherein said tray has a pan portion extending below said outer lip portion.

5. The saddlebag bird feeder of claim 1, wherein said strap has a sheet-like body.

6. The saddlebag bird feeder of claim 1, wherein said strap is composed of vinyl.

7. The saddlebag bird feeder of claim 1, wherein the window rests upon said middle portion of said strap during use.

8. The saddlebag bird feeder of claim 1, wherein said ballast bag has a pouch-like body portion and has an inlet for receiving ballast, whereby ballast can be added to said ballast bag to provide sufficient weight to pull said window sill abutment member into abutment with said window sill.

9. A decorative light assembly for mounting across a window sill of a window, the window sill having an outermost extent, comprising:
a ballast bag;
a flexible strap having a first end, a middle portion, and a second end; said first end of said flexible strap being connected to said ballast bag;
a window sill abutment member connected to said second end of said ballast bag;
a frame portion connected to said window sill abutment member;
a plurality of decorative lights supported by said frame;
a power source connected to said decorative lights;
a solar power array supported by said frame portion;
said power source including a battery, said power source being connected to said solar power array to store power.

10. The decorative light assembly of claim 9, further comprising an ON/OFF switch for selectively controlling power supplied by said power source to said decorative lights.

11. The decorative light assembly of claim 9, wherein said decorative lights include a plurality of light strings having down from said frame portion below the window sill.

12. The decorative light assembly of claim 9, wherein said window sill abutment member has an L-shaped body having a first portion attached to said strap and a second portion adapted to engage the outermost extend of the window sill.

13. The saddlebag bird feeder of claim 1, wherein said frame portion has a rectangular shape, and wherein said tray is a rectangular box-like member adapted to fit into said rectangular shape of said frame portion.

14. The saddlebag bird feeder of claim 1, wherein said frame portion has an extending flat portion acting as a ledge, and said frame portion further having two frame support members to support said frame portion from said window sill abutment member.
